(19) United States
(12) Patent Application Publication
(10) Pub. No.: US 2013/0154928 A1
(43) Pub. Date: Jun. 20, 2013

(54) Multilanguage Stroke Input System

(71) Applicant: LIANG HSI CHANG, Walnut, CA (US)

(72) Inventor: LIANG HSI CHANG, Walnut, CA (US)

(21) Appl. No.: 13/769,698

(22) Filed: Feb. 18, 2013

Related U.S. Application Data
(63) Continuation-in-part of application No. 11/902,026, filed on Sep. 18, 2007.
(60) Provisional application No. 61/614,458, filed on Mar. 22, 2012.

(51) Int. Cl. G06F 3/01

(52) U.S. Cl. CPC G06F 3/017
USPC 345/157

(57) ABSTRACT

A directional stroke input system has a display. A virtual key pad is displayed on the display, and the virtual keypad has an array of virtual keys. A cursor or a focus area placed on the virtual keypad at a selected key of the virtual keypad. A stroke recognition device includes a stroke sensing area. The stroke recognition device has eight straight directional strokes including: an up left stroke, an up stroke, an up right stroke, a left stroke, a right stroke, a down left stroke, a down stroke, and a down right stroke. The stroke recognition device has eight hook strokes including: an up left hook stroke, an up hook stroke, an up right hook stroke, a left hook stroke, a right hook stroke, a down left hook stroke, a down hook stroke, and a down right hook stroke.

This application is a Continuation In Part of the parent patent application serial Data Input System With Multi-Directional Pointing Device Ser. No. 11/902,026 by same inventor Liang Hsi Chang, which was published as U.S. Patent Publication No. 2009/0073003, entitled “Data Input System with Multi-directional Pointing Device”, filed on Sep. 18, 2007, the disclosure of which is incorporated herein by reference. This application also claims priority from same inventor Liang Hsi Chang provisional application No. 61/614,458 filed Mar. 22, 2012, entitled Data Input System With Sliding Gesture Controls, the disclosure of which is incorporated herein by reference.

### FIELD OF THE INVENTION

The field of the invention is in stroke input systems.

### DISCUSSION OF RELATED ART

Personal computers have traditionally been operated by input systems such as a keyboard. Later, trackball and mouse were added for additional functionality. With mobile phones becoming popular, users used telephone keypads for input on mobile phones. More recently, mobile phones have received greater processing power comparable to and exceeding the early personal computers of the 1990s. Input systems have developed and evolved over time, as electronic devices have become more powerful, smaller and more energy-efficient.

Touchpads became more prevalent for moving a cursor on a display with the advent of graphical user interface. Pen and tablet input systems allowed strokes to be input which was especially helpful for handwriting recognition such as for illustration and for Chinese characters.

A variety of different inventors have contributed to the field of input systems. John Elias and Wayne Westerman of FingerWorks disclosed an invention for User Interface Gestures in United States patent publication 20060238519 published Oct. 26, 2006, the disclosure of which is incorporated herein by reference. The user interface gestures included as stated by the abstract:
Apparatus and methods are disclosed for simultaneously tracking multiple finger and palm contacts as hands approach, touch, and slide across a proximity-sensing, multi-touch surface. Identification and classification of intuitive hand configurations and motions enables unprecedented integration of typing, resting, pointing, scrolling, 3D manipulation, and handwriting into a versatile, ergonomic computer input device.

If Touchscreen tablets became popular and have had a variety of technical improvements, such as those described by Ording U.S. Pat. No. 7,614,008 issued Nov. 3, 2009, the disclosure of which is incorporated herein by reference. Ording describes in the abstract that a touchscreen can be used with virtual keys.
A touch screen computer executes an application. A method of operating the touch screen computer in response to a user is provided. A virtual input device is provided on the touch screen. The virtual input device comprises a plurality of virtual keys. It is detected that a user has touched the touch screen to nominally activate at least one virtual key, and a behavior of the user with respect to touch is determined. The determined behavior is processed and a predetermined characteristic is associated with the nominally-activated at least one virtual key. A reaction to the nominal activation is determined based at least in part on a result of processing the determined behavior.

United States patent application publication 2006/0085757 by Andre published Apr. 20, 2006 also describes activating virtual keys of a touchscreen virtual keyboard, the disclosure of which is incorporated herein by reference. The Andre abstract describes:
A method of operating a touch screen to activate one of a plurality of virtual keys is provided. A touch location is determined based on location data pertaining to touch input on the touch screen, wherein the touch input is intended to activate one of the plurality of virtual keys. Each of the plurality of virtual keys has a set of at least one key location corresponding to it. For each of the virtual keys, a parameter (such as physical distance) is determined for that virtual key that relates the touch location and the set of at least one key location corresponding to that virtual key. The determined parameters are processed to determine one of the virtual keys. For example, the determined one virtual key may be the virtual key with a key location (or more than one key location, on average) being closest to the touch location. A signal is generated indicating activation of the determined one of the virtual keys.

Virtual keys are also called softkeys because they are constructed of software rather than hard keys which are hardware keys. Hardware keys are typically plastic and softkeys or virtual keys have an existence on a computer screen.

In addition to English user interface, touchscreen and tablet pen input has been used for Chinese character word processing, such as described in U.S. Pat. No. 6,075,469 issued Jun. 13, 2000 to inventor Pong for Three Stroke Chinese Character Word Processing Techniques And Apparatus, the disclosure of which is incorporated herein by reference. Pong suggested to count the number of different strokes of Chinese characters and cross-reference them to dictionary entries.

Virtual keys can also be activated by swipe gestures, such as described in Westerman, U.S. Pat. No. 8,059,101 issued Nov. 15, 2011 for swipe gestures for touchscreen keyboards, the disclosure of which is incorporated herein by reference. As can be seen from the above references in the field of input devices, a wide variety of different devices have been created for inputting a wide variety of different inputs in a wide variety of different ways.

Data input has been a challenging issue for handheld devices. Existing touch screen input often requires large keypad footprint to accommodate human finger sizes as well as pop-up key display to confirm correct data entries after each key press. Two-thumb typing is also error prone. Although prior art advances in input technology such as the Westerman swipe gestures have made certain improvements, they still have the problem that some users have very large fingers that would cover the display.

### SUMMARY OF THE INVENTION

A directional stroke input system has a display. A virtual key pad is displayed on the display, and the virtual keypad has an array of virtual keys. A cursor placed on the virtual keypad at a selected key of the virtual keypad. A stroke recognition device includes a stroke sensing area.

The stroke recognition device has eight straight directional strokes including: an up left stroke, an up stroke, an up right stroke, a left stroke, a right stroke, a down left stroke, a down stroke, and a down right stroke. The stroke recognition device has eight hook strokes including: an up left hook stroke, an up hook stroke, an up right hook stroke, a left hook stroke, a right hook stroke, a down left hook stroke, a down hook stroke, and a down right hook stroke. The stroke recognition device also has two loop strokes including: a counterclockwise stroke and a clockwise stroke; wherein the loop strokes execute an enter function and an exit function; and an input field for receiving text entry from the stroke recognition device.

The stroke sensing area can be a separate area or alternatively the stroke sensing area can overlap onto an on screen keypad guiding display. Optionally the input system may have a predictive text engine analyzing inputs made on the virtual keypad. The predictive text engine predicts words based on virtual key input strings entered. The clockwise stroke executes an enter function and the counterclockwise stroke executes a cancel function. The cursor is displayed on the display but can also be hidden. The cursor is any visual indicator of the selected key of the virtual keypad. The virtual keypad is a conventional 3×4 telephone keypad matrix having virtual keys with numerical digit names correlated to letters. The around the virtual keypad an outer ring is located on a first row, a first column and a last column of the array of virtual keys. Functions located on the virtual keys of the outer ring are automatically activated when the cursor moves to the outer ring.

It is an object of the present invention to achieve improvements as follows:
(1) Relative movement of gesture input:
   a. is independent of input devices' (i.e. touch-screen, mouse-pad and/or etc.) orientation or locations at any pre-defined sensing area with user-defined direction calibration references or historical user-behaviors.
   b. Minimum sliding distance is required which reduces the input sensing footprint/area and user efforts.
   c. Enable single-hand operations.
(2) Enable blind typing by using for example, a standard 3×4 phone key-pad and eighteen universal sliding gesture input controls memorable by users for multi-language data input, where users move the cursor by sliding from the home location of key 5 to activate the keys of 1,2,3,4,5,6,7,8,9,0, *, #.
(3) Separated input area and the keypad display areas which:
   a. Eliminate the finger blocking user vision problems found in most existing touch-screen input technologies.
   b. Reduce the 3×4 keypad display area down for visual purpose only without the need to design large keys to accommodate large fingers.
(4) The current invention is a language independent system where one set of strokes (same 18 strokes) is universally applicable to multi-language input applications. Other stroke input methods known so far are mostly language dependent where users need to learn specific set of graphical strokes system for each specific language.

### BRIEF DESCRIPTION OF THE DRAWINGS

FIG. 1 is a diagram of a 3×4 telephone keypad surrounded by an outer ring to make a 5×5 virtual keypad array.

FIG. 2 is a diagram of straight strokes including the clockwise and counterclockwise loops.

FIG. 3 is a diagram of hook strokes including the clockwise and counterclockwise loops.

FIG. 4 is a diagram of stroke recognition device recognizing a hook stroke.

FIG. 5 is a diagram of stroke recognition device recognizing a straight stroke.

FIG. 6 is a diagram of stroke recognition device recognizing a counterclockwise loop stroke.

FIG. 7 is a diagram of a Japanese syllabary virtual keypad layout, with a keyboard diagram below showing the derivation of the syllable arrangement on the virtual keypad layout.

FIG. 8 is a diagram of a QWERTY virtual keypad layout, with a keyboard diagram below showing the derivation of the letter arrangement on the virtual keypad layout.

FIG. 9 is a diagram of a fix function display screen.

FIG. 10 is a diagram of a list function display screen.

FIG. 11 is a diagram of a Chinese list function display screen where the Roman character pinyin is being correlated to Chinese dictionary entries.

The following call out list of elements can be a useful guide in referencing the call out numbers of the drawings.

111 First Row First Column Virtual Key

112 First Row Second Column Virtual Key

113 First Row Third Column Virtual Key

114 First Row Fourth Column Virtual Key

115 First Row Fifth Column Virtual Key

121 Second Row First Column Virtual Key

122 Second Row Second Column Virtual Keep

123 Second Row Third Column Virtual Key

124 Second Row Fourth Column Virtual Key

125 Second Row Fifth Column Virtual Key

131 Third Row First Column Virtual Key

132 Third Row Second Column Virtual Key

133 Third Row Third Column Virtual Key

134 Third Row Fourth Column Virtual Key

135 Third Row Fifth Column Virtual Key

141 Fourth Row First Column Virtual Key

142 Fourth Row Second Column Virtual Key

143 Fourth Row Third Column Virtual Key

144 Fourth Row Fourth Column Virtual Key

145 Fourth Row Fifth Column Virtual Key

151 Fifth Row First Column Virtual Key

152 Fifth Row Second Column Virtual Key

153 Fifth Row Third Column Virtual Key

154 Fifth Row Fourth Column Virtual Key

155 Fifth Row Fifth Column Virtual Key

21 Up Left Stroke

22 Up Stroke

23 Up Right Stroke

24 Left Stroke

25 Clockwise Loop Stroke

26 Right Stroke

27 Down Left Stroke

28 Down Stroke

29 Down Right Stroke

31 Up Left Hook Stroke

32 Up Hook Stroke

33 Up Right Hook Stroke

34 Left Hook Stroke

35 Counter Clockwise Loop Stroke

36 Right Hook Stroke

37 Down Left Hook Stroke

38 Down Hook Stroke

39 Down Right Hook Stroke

40 Stroke Recognition

41 Input Area

42 Stroke Ending

43 Stroke Apex

44 Stroke Beginning

45 Apex Vector

46 0° Angle

47 Apex Angle

61 Left Vector Sample

62 Right Vector Sample

88 Stroke Centroid

801 Step One

802 Step Two

803 Step Three

804 Step Four

805 Step Five

806 Predictive Text Selection List

807 Chinese Fix Function Mode

808 Cursor

### DETAILED DESCRIPTION OF THE PREFERRED EMBODIMENT

The present invention is electronic in nature. Electronic devices such as tablet computers, cell phones and other portable devices typically have a two dimensional input area such as a touchscreen or trackpad that allows receiving a two-dimensional input such as the swipe of a finger or stylus on the input area. The present invention uses strokes on an input area to move a cursor around on a virtual keypad that could be displayed on a screen such as a flat screen of a mobile personal electronic device. A cursor 808 can be a shaded field or button as well as a traditional arrow or bar. A cursor can be any indication of a selection.

An array of virtual keys includes five rows and five columns of virtual keys upon which a cursor resides. Virtual keys are not hard keys. Virtual keys are softkeys. Softkeys are made out of software just like virtual keys are made out of software. Virtual keys are constructed out of software preferably on a display such as an LCD display. Virtual keys and softkeys are buttons on a screen that can be activated by a stylus or touchscreen input. They can also be activated by a cursor such as a cursor controlled by an input device such as a mouse or trackball. A hardware input device such as a hard key is necessary for activating software keys such as virtual keys and softkeys. The preferred hardware input device in the present invention is a two-dimensional input such as a touchscreen or trackpad. Traditionally, a user typically uses the hardware input device to move the cursor over the virtual key and then presses a button on the hardware input device to activate the virtual key. The present invention does not require pressing a button on the hardware input device to activate the virtual key.

On a first row, the array of virtual keys preferably includes a first row first column virtual key 111, a first row second column virtual key 112, a first row third column virtual key 113, a first row fourth column virtual key 114, and a first row fifth column virtual key 115. On a second row, the array of virtual keys preferably includes a second row first column virtual key 121, a second row second column virtual key 122, a second row third column virtual key 123, a second row fourth column virtual key 124, and a second row fifth column virtual key 125. On a third row, the array of virtual keys preferably includes a third row first column virtual key 131, a third row second column virtual key 132, a third row third column virtual key 133, a third row fourth column virtual key 134, and a third row fifth column virtual key 135. On a fourth row, the array of virtual keys preferably includes a fourth row first column virtual key 141, a fourth row second column virtual key 142, a fourth row third column virtual key 143, a fourth row fourth column virtual key 144, and a fourth row fifth column virtual key 145. On a fifth row, the array of virtual keys preferably includes a fifth row first column virtual key 151, a fifth row second column virtual key 152, a fifth row third column virtual key 153, a fifth row fourth column virtual key 154, and a fifth row fifth column virtual key 155.

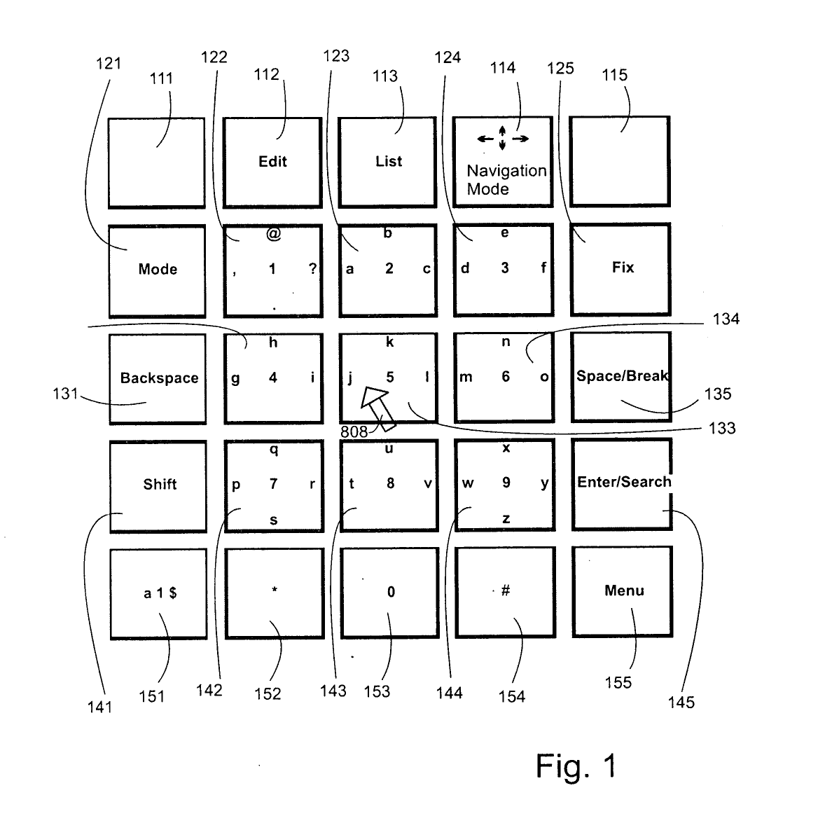

Each of the virtual keys on the array of virtual keys can be assigned different functionality as seen in FIG. 1. For example, first row first column virtual key 111 can be assigned a functionality of nothing. Activating first row first column virtual key 111 does nothing. In contrast, first row second column virtual key 112 can activate an edit menu. First row third column virtual key 113 can be assigned a functionality of list so as to list candidates of words from a predictive text dictionary.

Activating first row fourth column virtual key 114 enables a cursor navigation mode. Cursor navigation mode is different than input mode because cursor navigation mode only moves the cursor and does not make any input. During cursor navigation mode, the cursor is moved in the direction of the hand movement entered by the user. During cursor navigation mode, the hook stroke is disabled. Cursor navigation mode is not limited to the eight directions and the cursor acts as a mouse or other kind of typical pointer device such as a trackpad. An exit area can be defined in the cursor navigation mode to escape the cursor navigation mode to switch back to the stroke input mode.

Second row first column virtual key 121 can activate a ‘mode’ function to change the mode of the keyboard, such as a language mode from English to Japanese or from text to symbols such as a star, happy face or other decorative emotes that can be animated with fun colors and happy sounds. For example, the ‘mode’ function can cycle through languages each time a user activates the mode function. Second row second column virtual key 122 can be a digit ‘1’ or can represent other input such as ‘@’,‘.’ or ‘?’. A second row third column virtual key 123 can represent a digit ‘2’ or characters such as ‘a’, ‘b’, or ‘c’. A second row fourth column virtual key 124 can represent a digit ‘3’ or characters such as ‘d’, ‘e’, or ‘f’. A second row fifth column virtual key 125 can be assigned to activate a ‘fix’ menu. A third row first column virtual key 131 can be assigned a backspace function. A third row second column virtual key 132 can represent a digit ‘4’ or characters such as ‘g’, ‘h’, or ‘i’. A third row third column virtual key 133 can represent a digit ‘5’ or characters such as ‘j’, ‘k’, or ‘l’. A third row fourth column virtual key 134 can represent a digit ‘6’ or characters such as ‘m’, ‘n’, or ‘o’. A third row fifth column virtual key 135 can represent a space or break function. A fourth row first column virtual key 141 can represent a shift function. A fourth row second column virtual key 142 can represent a digit ‘7’ or characters such as ‘p’, ‘q’, or ‘r’. A fourth row third column virtual key 143 can represent a digit ‘8’ or characters such as ‘t’, ‘u’, or ‘v’. A fourth row fourth column virtual key 144 can represent a digit ‘9’ or characters such as ‘w’, ‘x’, ‘y’ or ‘z’. A fourth row fifth column virtual key 143 can represent an ‘enter’ or ‘search’ function. A fifth row first column virtual key 151 can be assigned to a toggle function for toggling between regular character and special character entry. A fifth row second column virtual key 152 can be assigned to an asterisk which can be helpful when dialing on a telephone. A fifth row third column virtual key 153 can be assigned to a ‘0’ digit. A fifth row fourth column virtual key 154 can be assigned to a pound or hash ‘#’ function. A fifth row fifth column virtual key 155 can be assigned to a menu function for calling up a menu.

In the virtual key keypad layout example shown in FIG. 1, a standard keypad layout can be shown as a conventional 3×4 telephone keypad, but can also be a matrix of on-screen icons or any other keyboard layout. There could also be an outer ring around the traditional 3×4 telephone keypad as shown in FIG. 1. The outer ring, as shown in FIG. 1, includes the first column, the fifth column and the first row. The 3×4 telephone keypad, as shown in FIG. 1, includes the remainder of the virtual keys not in the outer ring. The combination of the 3×4 virtual telephone keypad and the outer ring provides the 5×5 virtual key array.

Initially, the user starts with the cursor at the home position. The cursor can be shown as an arrow, a shaded portion of the virtual key, or other graphically interesting embodiments. The home position is preferably the number ‘5’ on the keypad which is the third row third column virtual key 133. To move the cursor from the home position to another position, the user inputs a stroke. The cursor moves in the direction of the stroke. The direction of the stroke is taken by maintaining time data to record vector data of the stroke.

The preferred embodiment uses only 18 strokes including: up left stroke 21, up stroke 22, up right stroke 23, left stroke 24, clockwise stroke 25, right stroke 26, down left stroke 27, down stroke 28, down right stroke 29, up left hook stroke 31, up hook stroke 32, up right hook stroke 33, left hook stroke 34, counter clockwise stroke 35, right hook stroke 36, down left hook stroke 37, down hook stroke 38, down right hook stroke 39. Each of the eight different directions have a stroke and a hook stroke. In addition, a clockwise stroke 25 and a counter clockwise stroke 35 are used. Therefore, the strokes can be input by sliding gestures and movements of a human finger on a touch screen. The strokes are preferably limited to total of 18 so that there is no requirement for any other finger movement such as the pressing of keyboard keys, the clicking of a mouse, or pressing of virtual keyboard keys.

The stroke is captured using a stroke recognition device 40. The stroke recognition device has an input area 41 that is a two-dimensional flat input such as a trackpad or touchscreen. The two-dimensional input has a first coordinate and a second coordinate such as an x coordinate and a y coordinate. As a user draws a stroke on the stroke recognition device, the stroke recognition device receives a stroke input. A number of different methods can be used to interpret the stroke input so as to correspond to one of the 18 strokes.

The stroke recognition recognizes slide movement that can be defined with a starting action for example, an initial finger touch contact, separate physical button or a starting command such as a voice or any distinguishable signal coupled with directional sliding movement. The stroke can be terminated with an ending action for example, lifting the finger to break a capacity of sensing touch contact or an ending command such as a voice or any other kind of distinguishable signal.

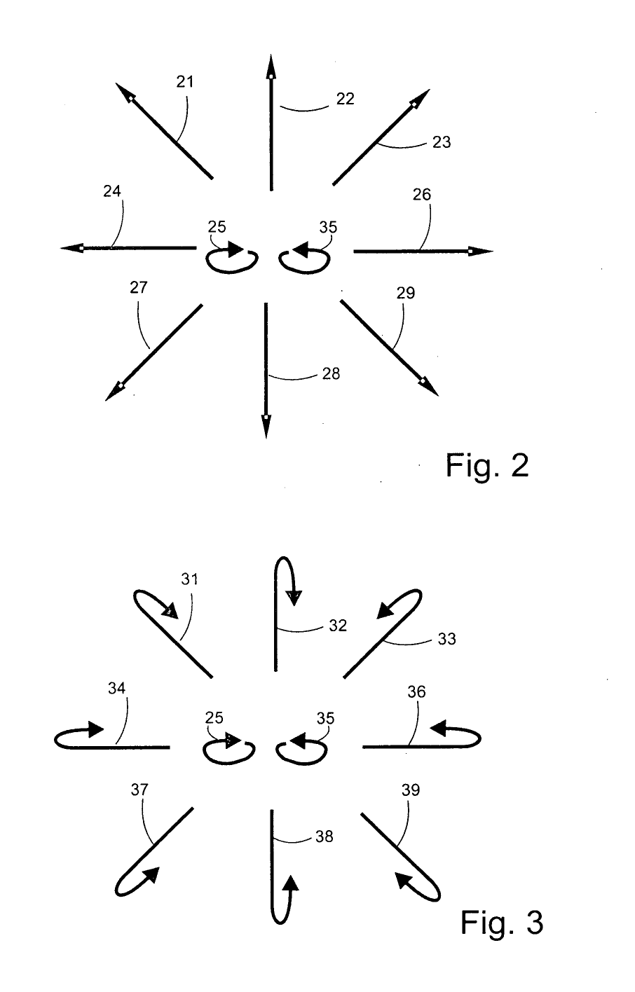

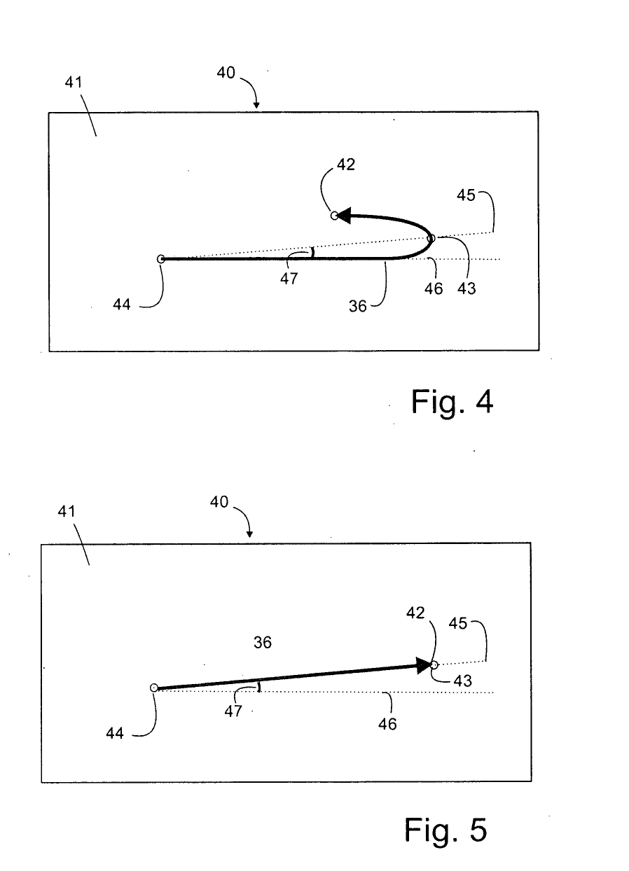

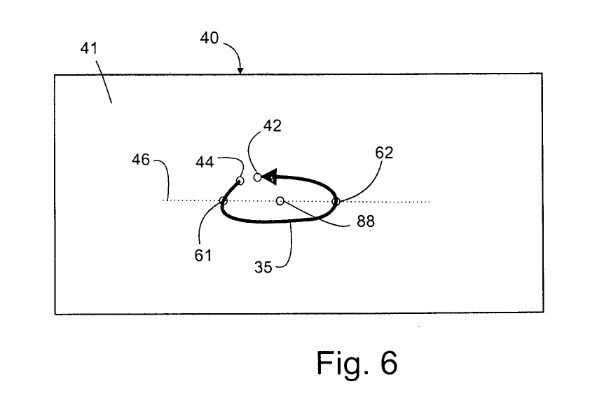

According to FIG. 2 and FIG. 3, each stroke is input sequentially. The stroke can start from any portion of the stroke recognition area and does not need to begin from a middle portion of the stroke recognition area.

For example, the stroke recognition device can receive a stroke ending 42 and stroke beginning 44. A stroke apex 43 can be calculated as the location of the stroke furthest away from the stroke beginning 44. The stroke apex 43 also has an apex vector 45 which is the vector beginning from the stroke beginning 44 and pointing to the stroke apex 43. The apex angle 47 can be calculated from the angle between the zero angle line 46 which is a horizontal line and the apex vector 45.

To determine the direction of the stroke, the apex vector can be used. The stroke recognition device can determine the direction that apex vector is pointing. The eight different directions can be partitioned into different angles. Since 360° divided by eight equals 45°, each of the eight directions can have a 45° arc such that for example a right stroke would be 0° plus or minus 22.5° in each direction. A left stroke would be 180° plus or minus 22.5° in each direction. An up stroke would be 90° plus or minus 22.5° in each direction. A down stroke would be 270° plus or minus 22.5° in each direction. The stroke recognition device can compare the apex vector with the closest angle relating to the closest assigned stroke to determine the direction of the stroke.

To determine if the stroke is a hook or straight stroke, a rule can be used such as if the distance between the stroke apex 43 and the stroke ending 42 is less than a set percentage of the distance between the stroke apex and the stroke beginning, then the stroke is a straight stroke rather than a hook. The set percentage can be a percentage that can be set by the user such as 10%.

If the distance between the stroke ending and the stroke beginning is less than the distance between the stroke apex and the stroke beginning, then the stroke is a circular stroke, which is a clockwise stroke 25 or counterclockwise stroke 35. A circular stroke could also be determined to have occurred if the distance between the stroke beginning and the stroke ending is smaller than the distance between the stroke apex and the stroke ending.

The stroke centroid 88 can also be calculated by taking the centroid of the stroke. The horizontal bisecting line which is also the zero angle line 46 passes through the stroke centroid 88 and for a counter clockwise stroke the zero angle line 46 passes through the stroke at a left vector sample location 61 and a right vector sample location 62. The stroke input device can sample the vector of both of the locations to determine if the stroke is passing in a clockwise or counterclockwise direction.

A number of different rules could be used. It could be simplified rules that use geometry theory and rely only on arithmetic or it could be also a traditional handwriting recognition method commonly used for-input of Chinese characters or English alphabets. The goal of the invention is to provide one set of strokes which is intuitive and internationally applicable for multi-language input applications. The strokes can be called universal strokes or sliding gesture control movements. The universal nature of the data input system is derived from allowing a single-set of strokes operation to be used in different languages. The physical apparatus that can use this stroke input system include a variety of applications. The applications include smart phones, cell phones, TV, Digital Camera, PDA, GPS devices, Gaming devices, electronics menus, remote controls, touch panels, mouse pads, touch screens, products such as for example NB, Tablet PCs, iPhones, iPads and relative position sensing surfaces such as a sensor pad designed for 2-finger operation or wireless sensors. The present invention can work on high processing power personal computers, but is designed for low power consumption mobile devices and wireless remote controls. During implementation, it is suggested to minimize as much as possible, the amount of power consumption and processing power required.

Up until now, this specification has described a keypad layout and strokes to move a cursor on the keypad layout. When the stroke recognition device 40 recognizes a directional stroke, the cursor will move from the home direction in the direction of the directional stroke. With reference to FIG. 1, straight strokes move the cursor from the home position at the 5 key which is the third row third column virtual key 133. The up left stroke 21 moves the cursor up and left to the 1 key which is the second row second column virtual key 122. The up stroke 22 moves the cursor to the up to the 2 key which is the second row third column virtual key 123. The up right stroke 23 moves the cursor up and right to the 3 key which is the second row fourth column virtual key 124. The left stroke 24 moves the cursor left to the 4 key which is the third row second column virtual key 132. The clockwise stroke 25 activates the 5 key which is the home location which is the third row third column virtual key 133. The right stroke 26 moves the cursor right to the 6 key which is the third row fourth column virtual key 134. The down left stroke 27 moves the cursor down and left to the 7 key which is the fourth row second column virtual key 142. The down stroke 28 moves the cursor down to the 8 key which is the fourth row third column virtual key 143. The down right stroke 29, moves the cursor down and right to the 9 key which is the fourth row fourth column virtual key 144. Moving the cursor to a virtual key not in the outside ring will not automatically activate the virtual key. The user can input a left stroke and then a right stroke so that the user leaves the home position and then comes back to the home position.

The cursor can be any visual indicators such as a shaded area of a box and can be an arrow. The cursor is located on a selected virtual key when the cursor is in input mode, but when the cursor is not in input mode and in the navigation mode, the cursor has free movement like a standard cursor moved by a trackpad.

When the stroke recognition device 40 recognizes a directional hook stroke, the cursor will move from the home direction in the direction of the directional hook stroke and activate the key that it travels to. With reference to FIG. 1, directional hook strokes move the cursor from the home position at the 5 key and then activate the keys that it travels to. The up left hook stroke 31, activates key 1. The up hook stroke 32 activates key 2. The up right hook stroke 33 activates key 3. The left hook stroke 34 activates key 4. The counter clockwise stroke 35 is an undo function and does not activate a key. The right hook stroke 36 activates key 6. The down left hook stroke 37 activates key 7. The down hook stroke 38 activates key 8. The down right hook stroke 39 activates key 9. In this way, a user can activate keys 1-9 using the directional hook stroke and the clockwise stroke 25. User can also use combinations of these 18 universal strokes to move around the 5×5 key array area and activate/deactivate any keys or outside ring functions. This method can also achieve the full-functioned input capability of a standard QWERTY keyboard in various languages by a single hand operation of the same set of strokes.

If a user wanted to activate functions in the outside ring, the user would have to input a straight directional stroke and then another stroke. For example, if the user wanted to activate the space function, the user would input a right stroke 26 and then another right stroke 26. Optionally, a user could input a right stroke 26 and then a right hook stroke 36. Once the cursor travels to the outside ring, the function in the outside ring is automatically activated. A user could also move the cursor circuitously on the 3×4 keypad before moving the cursor to the outside ring. For example, a user could move to cursor from the 5 key, to the 2 key, to the 3 key, to the 6 key before activating the space by inputting a right stroke 26.

On a numeric keypad, a user can enter a string of numbers for dialing a telephone or facsimile for example. For entering letters, a user can use the numbers to represent groups of letters or other characters in a predictive text algorithm. In building the present invention, it is suggested not to craft a predictive text engine from scratch but to obtain a license for any one of the widely available engines that are commonly and commercially available. A large number of different predictive text technologies have been described in the prior art which are suitable for use in the present invention, including improvements described in inventor Jason Griffin United States patent publication 2005/0283724 published Dec. 22, 2005, entitled predictive text dictionary population, the disclosure of which is incorporated herein by reference. There are also a wide variety of different predictive text engines that are open source. If no predictive text method is desired, other commonly used multi-tap methods could also be used after a key is activated by this universal strokes method. For example, if key 2 is activated, the user can cycle through and activate the data/function assigned in key 2 such as “a”→“b”→“c”→“2”→“a”→“b”→, by continuous tapping or clicking on the input device ending with any confirmation signal.

Wikipedia describes predictive text technology as follows:
Predictive text is an input technology used where one key or button represents many letters, such as on mobile phones' numeric keypads and in accessibility technologies. Each key press results in a prediction rather than repeatedly sequencing through the same group of “letters” it represents, in the same, invariable order. Predictive text could allow for an entire word to be input by single keypress. Predictive text makes efficient use of fewer device keys to input writing into a text message, an e-mail, an address book, a calendar, and the like.

The directional stroke system, also called a gesture sliding movement input system may be integrated with a predictive text software program or engine to simplify input to predict words based on numerical input strings entered. Generally speaking, over 95% of commonly used words may be found in most predictive text software dictionaries.

Some examples will now be given as to how the strokes, once recognized will use the keypad layout using a predictive text software engine to improve data input efficiency. For text input, the cursor starts from key #5, FIG. 1 as the home or starting location and is moved to any on-screen key location by the directional stroke also called gesture sliding movements.

To enter any text listed on the array of virtual keys which can be an on screen displayed keypad, the user could use 10 out of the 18 directional stroke movements that do not have the U-turn hooks, namely: up, down, left, right, left up, right up, left down, right down, clockwise circle and counter clockwise circle. Each of the strokes can move or navigate the cursor to the desired virtual key and activate or escape from the virtual key function where the cursor is located. The word ‘move’ is used here synonymously to the word ‘navigate’.

To input the English word “good” a user will input its associated numerical string of 4, 6, 6, 3 because: the third row second column virtual key 132 represents digit ‘4’ or characters ‘g’, ‘h’, or ‘i’; the third row fourth column virtual key 134 represents digit ‘6’ or characters ‘m’, ‘n’, or ‘o’. The second row fourth column virtual key 124 represents digit ‘3’ or characters ‘d’, ‘e’, or ‘f’. The user uses the directional stroke is also a sliding gesture movement to move from the home starting location key number five to the desired virtual key. After the user is at the desired virtual key, the user can input a clockwise circular to press the virtual key by activating the enter function, or the user can input a counterclockwise circular movement to escape and go back to the home starting location.

The user can input the numerical string 4663 example above by starting from the home location key 5 and then inputting a left stroke to slide the cursor left to key 4 which has characters ‘g’, ‘h’, or ‘i’ associated with it. The cursor will return to the home starting location after the user inputs a clockwise circular motion to activate the enter function to press key 4. Here, the key numbers are being used as names only and numbers are not being inputted because the virtual key array is in text entry mode rather than number entry mode. In a number entry mode, the number of the key would be entered but in text entry mode, the character associated with the key is entered. Starting again from the home location of key 5 the user slides the cursor right to key 6 by inputting a right stroke and inputting a clockwise circular stroke 25. After the clockwise circular stroke 25, the cursor returns to the home location of key 5. Activating key 6 is then repeated with the same step. The user then slides right and up with an up right stroke, or with an up stroke first and then a right stroke. When the user moves the cursor to key 3, the user inputs a clockwise loop stroke 25 to activate the selected key.

An alternate method for inputting the string 4663 in the example above uses the hook strokes. The hook strokes can be hooked in any direction and the clockwise or counterclockwise orientation of the hook is not relevant. The hook strokes simplify the input process because the hook acts as a combination of a directional straight stroke with a clockwise loop stroke. Inputting the string 4663 can be done by inputting a left hook stroke, then two right hook strokes, then an up right hook stroke. After each hook stroke, the cursor returns to home position at key 5.

This inputs the string 4663 which on a telephone keypad correlates to several possible different words. To select the correct word, the user must go to the list function display and leave the telephone keypad temporarily. The user activates the list function which is positioned above virtual key 2 by inputting two up strokes 22. After the first up stroke, the user is still on the 3×4 telephone keypad area. When the user inputs the second up stroke 22, the list function is automatically activated because it is outside of the 3×4 telephone keypad area. All functions outside of the 3×4 telephone keypad area are automatically activated.

The predictive text selection list 806 will display likely candidates on the screen display as seen in FIG. 10. The list function has a list of ambiguous words including good, home, gone, hood.

Then users can select the desired word from the list by moving the cursor up, down, left or right and then conduct a clockwise loop stroke which can be a clockwise circular movement of the finger to select the word “good” as seen in FIG. 10. Alternatively, users can also select the desired word from the list by moving the cursor up, down, left or right to the adjacent key location and then conducting any of the eight hook strokes which can be a U-turn movement of the finger to move to and activate the word good.

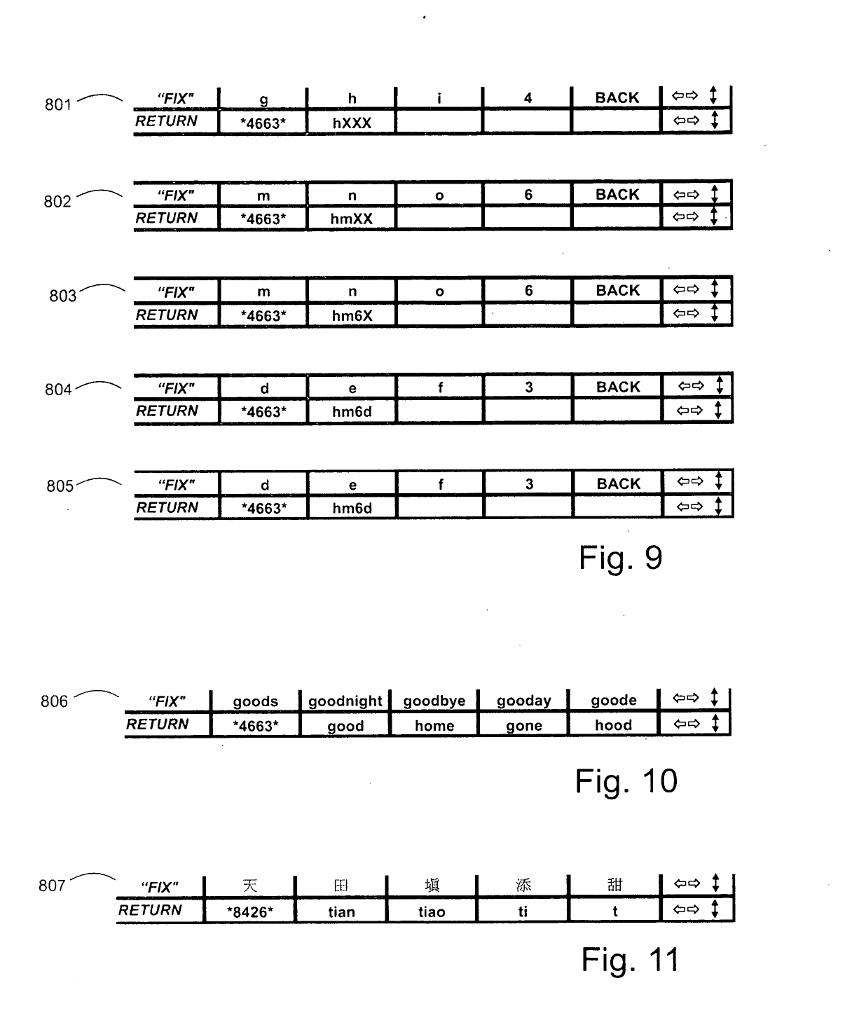

Users can use the fix function to enter specific combinations of letters that does not make any words that would appear in dictionaries such as password text. A password such as “hm6d” could be individually adjusted and specified by activating the fix function in the outside ring after the 4663 string is entered. Cursor location is then in the candidate list area where user can sequencially adjust and select any specific letter along the input string digits of 4663 or back to change the prior digit specified. A user navigates to the fix function by moving the cursor to the fix function which automatically activates and since the user to the fix function display screen as seen in FIG. 9.

The user first inputs the string 4663 as previously shown above. A password such as “hm6d” requires using the fix function and executing several steps. In a first step 801, for the 1^{st} digit of the string 4663, the user moves the cursor along the fix function letter candidate list of g,h,l,4. In the first step 801, the user navigates to the letter H and selects the virtual key using the clockwise loop stroke, which can be activated from a clockwise circular movement of a finger. After the 1^{st} digit is fixed, in a second step 802, the user moves the cursor along the letter candidate list of m,n,o,6 to the letter M and the user then activates the virtual key corresponding to the letter M by selecting the M with the clockwise loop stroke. In a third step 803, the user moves the cursor to the numeral ‘6’ along the candidate letter list of m,n,o,6 and select the ‘6’ using the clockwise loop stroke 25, in a fourth step, the user moves to the letter D location in the letter candidate list and confirm the letter D with the clockwise loop stroke. Fixing each letter/data for the 4663 digits is processed sequentially. If the data fixed prior needs be changed again, user can select and activate the BACK function in the candidate list any number of times to move the cursor backward to alter and fix the prior data for each digit again sequentially. Note that when a user selects a date in the candidate list, the user does not use a finger to press on the touchscreen display, but rather only uses the clockwise loop stroke 25. In this way, user does not need to shift position of a hand and can maintain the same grip on the portable electronic device. The clockwise loop stroke can be small in diameter, such as half an inch so that a user does not need to reach across to the other side of the touchscreen display to press a button. In a fifth step 805, the user activates the adjusted data of “hm6d” or the original form of “4663” by a clockwise stroke or exiting/cancelling the Fix mode and return to the regular input mode by selecting and activating the return function on the fix function menu. This exits the fix function menu so that a user can get back to inputting other text.

Instead of using the straight stroke with clockwise loop stroke 25, a user can use any of the eight hook strokes that can be implemented by a U-turn movement of a finger on a touch screen. The clockwise loop stroke can move to and activate the next adjacent letter/data.

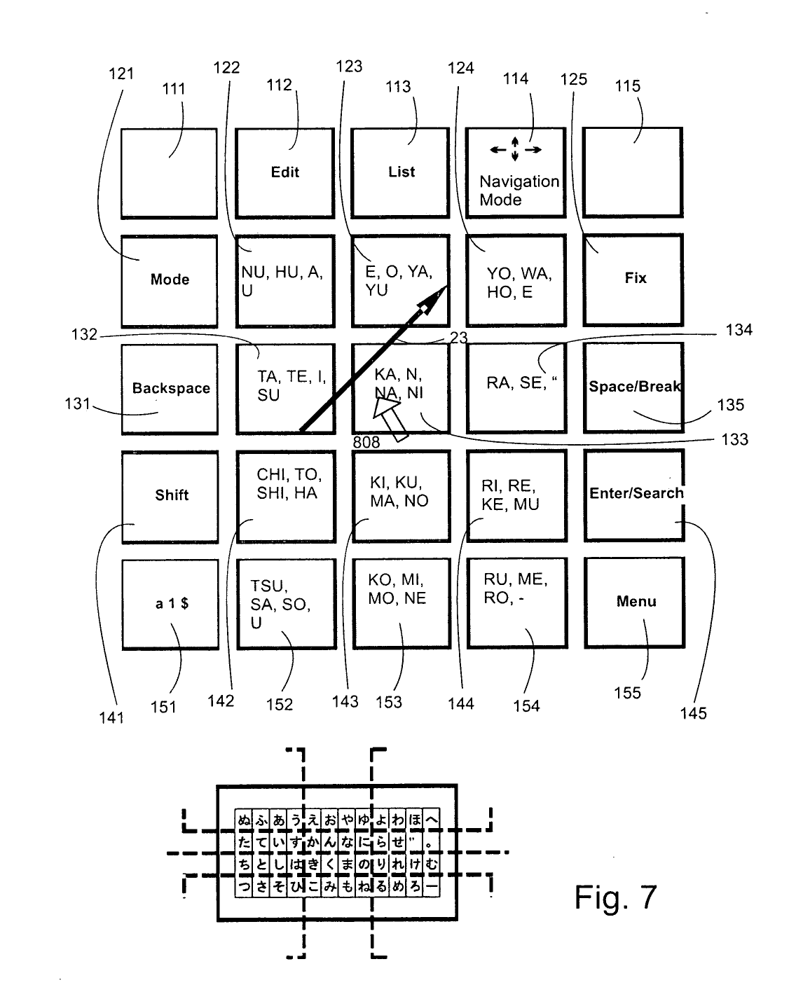

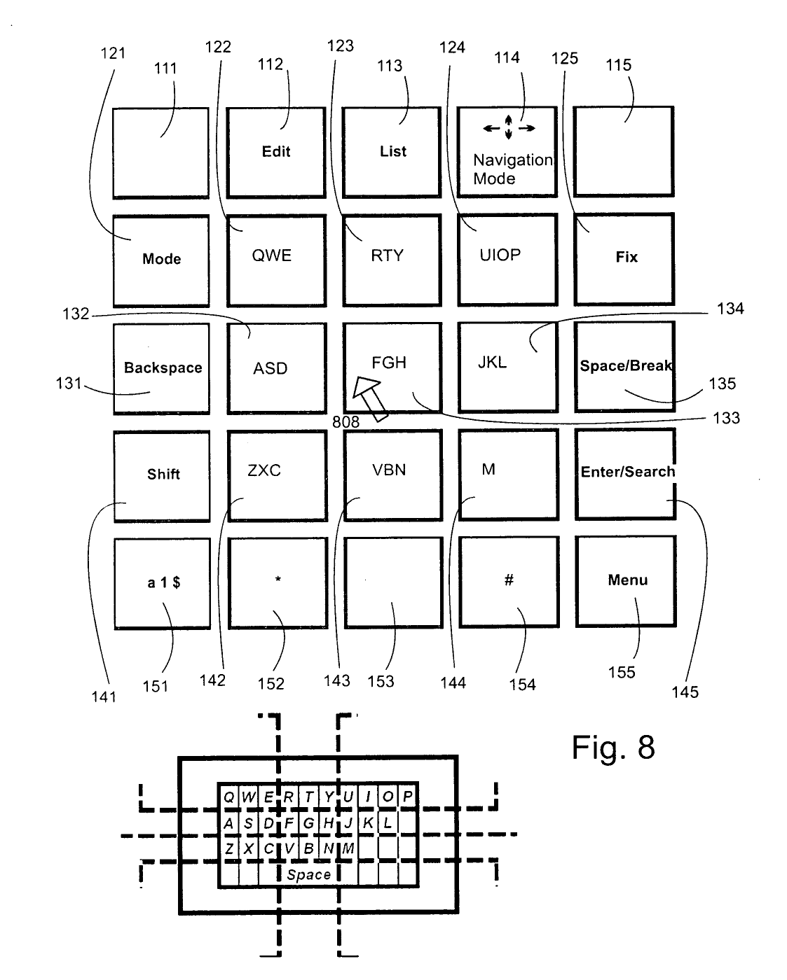

Once a user returns to the 3×4 keypad, the user may want to enter other languages. Other languages can be entered using the mode function menu. The mode can be toggled by the ‘mode’ virtual key button, which is shown as the second row first column virtual key 121, FIG. 1. Different modes may include Japanese. The array of virtual keys can be modified as shown in FIG. 7 to input entire syllables rather than letters. The syllables could be Japanese hiragana for example. The syllables can be represented by hiragana symbols, or by romaji or by one or more ASCII letters. The keyboard below the diagram in FIG. 7, 8 shows the derivation of the layout. After a sequence of syllables is entered, a predictive text dictionary can provide proposed words. As shown in FIG. 8, the array of virtual keys can also be laid in a QWERTY keyboard arrangement in yet a different mode. Moving the cursor to the mode virtual key button can change the mode automatically by auto activating the ‘mode’ function. Another mode could be a Chinese mode as seen in FIG. 11. A user can access Chinese pinyin mode which looks just like the English mode except that the fix and list function of the Chinese mode has a Chinese dictionary such as in the Chinese fix function mode step 807.

After users become familiar with the 3 x 4 telephone keypad layout, users can turn off the virtual keypad layout display so that the finger gestures are being performed over the application in an overlay which would allow full vision of the application that the user is currently using. This would eliminate the keypad layout display as well as the visible cursor. The cursor would only become visible when functions in'the outer ring are activated such as when a list of words is being listed for the user to select from.

The stroke sensing area can be a separate area as seen in FIG. 1. Alternatively, the stroke sensing area can overlap onto the on screen keypad guiding display such as the virtual key array as seen in FIG. 7. where a directional up right stroke 23 is overlaid on the virtual key array display. The stroke is preferably of a contrasting color from the virtual key array display so that a user can see the stroke easily.

During the overlay display mode, if the user is using a touch screen, the user will be moving a finger over the display of the virtual keypad buttons, but the user will not activate any of the buttons on the touch screen by virtue of moving a finger over them. The user will only activate the buttons when the user executes the clockwise rotation command or any hook stroke. This may seem counterintuitive to have to use strokes to move a cursor on a keypad when a user could simply press the virtual keypad buttons that the user wants, however if the screen is small, the overlay display mode is miniaturized such that the user would not be able to reliably press the correct button. In a miniaturized situation where the overlay display is less than 3 inches high and 3 inches wide, the overlay display mode allows user interaction with the virtual keypad key buttons even if the user has very large fingers. Optionally, for persons that have very small fingers, the system could be designed so that a user could turn off the input system of the present invention by going to a mode button shown as the second row first column virtual key 121 or by going to any other assigned button on the outer ring such as first row fifth column virtual key 115 by two up-right strokes from the home location, key 5.

The present invention is not designed to be a standalone device, but is designed to be used in conjunction with a personal electronic device. The present invention can be implemented by software alone as an application capable of being run on existing hardware devices.

1. A directional stroke input system comprising:
a. a display; and
b. a virtual key pad displayed on the display, wherein the virtual keypad has an array of virtual keys;
c. a cursor placed on the virtual keypad;
d. a stroke recognition device having:
i. a stroke sensing area;
ii. eight straight directional strokes including: an up left stroke, an up stroke, an up right stroke, a left stroke, a right stroke, a down left stroke, a down stroke, and a down right stroke;
iii. eight hook strokes including: an up left hook stroke, an up hook stroke, an up right hook stroke, a left hook stroke, a right hook stroke, a down left hook stroke, a down hook stroke, and a down right hook stroke;
iv. two loop strokes including: a counterclockwise stroke and a clockwise stroke; wherein the loop strokes execute an enter function and an exit function; and
e. an input field for receiving text entry from the stroke recognition device.

2. The directional stroke input system of claim 1, wherein the stroke sensing area is a separate area from the display.

3. The directional stroke input system of claim 1, wherein the stroke sensing area overlaps onto an on screen keypad guiding display that is on the display.

4. The directional stroke input system of claim 1, further comprising a predictive text engine analyzing inputs made on the virtual keypad, wherein the predictive text engine predicts words based on virtual key input strings entered.

5. The directional stroke input system of claim 1, wherein the clockwise stroke executes an enter function and wherein the counterclockwise stroke executes a cancel function.

6. The directional stroke input system of claim 1, wherein the cursor is displayed on the display.

7. The directional stroke input system of claim 1, wherein the virtual keypad is a conventional 3×4 telephone keypad matrix having virtual keys with numerical digit names correlated to letters.

8. The directional stroke input system of claim 1, further comprising an outer ring located on a first row, a first column and a last column of the array of virtual keys, wherein functions located on the virtual keys of the outer ring are automatically activated when the cursor moves to the outer ring, wherein the outer ring has a mode function to change language, wherein an outer ring and a conventional 3×4 telephone keypad form a 5×5 virtual keypad matrix.

9. The directional stroke input system of claim 8, wherein the stroke sensing area is a separate area from the display.

10. The directional stroke input system of claim 8, wherein the stroke sensing area overlaps onto an on screen keypad guiding display that is on the display.

11. The directional stroke input system of claim 8, further comprising a predictive text engine analyzing inputs made on the virtual keypad, wherein the predictive text engine predicts words based on virtual key input strings entered.

12. The directional stroke input system of claim 8, wherein the clockwise stroke executes an enter function and wherein the counterclockwise stroke executes a cancel function.

13. The directional stroke input system of claim 8, wherein the cursor is displayed on the display.

14. The directional stroke input system of claim 8, wherein the virtual keypad is a 5×5 keypad matrix that consists of an outer ring and a conventional 3×4 telephone keypad matrix having virtual keys with numerical digit names correlated to letters.
